(19) United States
(12) Patent Application Publication
(10) Pub. No.: US 2008/0311224 A1
(43) Pub. Date: Dec. 18, 2008

(54) Long-lasting mildew stain remover and method for making same

(76) Inventors: Meghan Gressler, Basking Ridge, NJ (US); Ernest Bernarducci, Rutherford, NJ (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 12/080,648

(22) Filed: Apr. 4, 2008

Related U.S. Application Data
(62) Division of application No. 11/820,240, filed on Jun. 18, 2007.

(51) Int. Cl. A01N 59/08; A01P 3/00

(52) U.S. Cl. 424/665

(57) ABSTRACT

The active life of a fungicidal metal hydrochlorite is greatly enhanced by adding only small amounts of active fungicidal compounds selected from the group consisting of lithium hydrochlorite and iodopropynyl butyl carbamate.

This is a divisional of application Ser. No. 11/820,240 of Jun. 18, 2007.

### BACKGROUND OF THE INVENTION

Many compositions have been proposed for application to surfaces in order to remove microorganisms such as mildew and fungi from those surfaces. Particularly effective in this regard are alkali metal hypochlorites, of which sodium hypochlorite is generally selected, primarily for economic reasons. One problem with such fungicidal compositions is that their effectiveness when applied to surfaces does not last very long, particularly in connection with prevention of renewed mildew growth. As a result frequent re-application on the same surface is called for, with consequent disadvantages of cost and trouble.

The problem of extending the fungistatic properties of fungicidal compositions of the alkali metal hypochlorite type has been recognized, and various relatively complex and expensive proposals have been made to achieve that longer-lasting effect, among which is the concept of adding thickening agents to the compositions so as to inhibit the flow of the compositions on the surfaces, often vertical, to which it is applied. This approach has many disadvantages, among which are cost of ingredients and difficulty in formulation and application of the composition, as well as possibly being hazardous to the user or not particularly suitable for use on the particular surface to be treated.

It is therefore the object of the present invention to provide a relatively simple, easily prepared and highly effective fungicidal composition which, when once applied to a surface, will continue to have an anti-fungicidal action for an extended period of time, providing both mildew removal and prevention in one formulation.

### SUMMARY OF THE INVENTION

We have discovered that the active life of alkali metal hypochlorite compositions, of which sodium hydrochlorite is most commonly used, largely for reasons of cost, particularly in connection with inhibiting the growth of new mildew, can be greatly enhanced by adding thereto small amounts of certain other known fungicidal compositions. The result of that addition does not appreciably increase the intensity of the fungicidal effect of the composition, no doubt because of the small amount of the other constituent which is added, but, surprisingly, that addition does greatly increase the length of time that the composition, when applied to a wall or other surface, will continue to have a fungicidal effect. The two fungicides we have discovered that will have this fungicidal effect on time of efficacy are lithium hypochlorite and 3-iodo-2-propenyl butyl carbamate (“IPBC”), one commercial version of which is sold under the tradename Glycacil.

While commercial sodium hypochlorite stain removal composition have a surface life of just two weeks, requiring re-application of the composition that frequently, the composition of the present invention removed mildew and, surprisingly, prevented formation of new mildew for more than four weeks after application, with obvious advantages.

We started with commercial fungicidal compositions comprising sodium hypochlorite 12% in strength dissolved in water together with small amounts of commercial additives, to with, sodium carbonate as a builder and sodium bicarbonate as a buffer. These commercial compositions and such compositions modified according to the present intention were applied to bathroom tiles in normal fashion and the tiles were allowed to dry. Mildew innoculum was prepared and placed on each of the tiles and the tiles were then placed in a humid environment. After a week, the tiles were checked for mildew growth, more mildew innoculum was applied and the tiles were placed back in the humid environment. This process was continued each week until a time period of four weeks or until significant mildew was seen on all of the tiles, whichever came first. With the conventional compositions significant mildew appeared in just over two weeks, but when the tiles were treated with the composition of the present invention significant mildew did not appear even after four weeks.

Set forth below are several formulations which exhibit enhanced effective life. They represent conventional sodium hydrochlorite fungicidal compositions to which active-life-extending compositions have been added. The formulae are set forth in terms of the amounts of active constituents because the commercial compositions in their commercially available forms will vary somewhat in their proportions of active and inactive components. Formulas 1, 2 and 3 illustrate the use of IPBC to produce a longer effective life, whereas formulas 5 and 5 illustrate the use of lithium hydrochlorite for the same purpose.

Formula 1

| RAW MATERIAL | % WT/ |
|---|---|
| Water | 93.917 |
| Active sodium hydrochlorite | 4.400 |
| Sodium Carbonate | 1.120 |
| Sodium Bicarbonate | 0.560 |
| Active 3-iodo-2-propynyl butyl carbamate (6% in Glycacil) | 0.003 |
| | 100.000 |

Formula 2

| RAW MATERIAL | % WT/ |
|---|---|
| Water | 93.911 |
| Active sodium hydrochlorite | 4.400 |
| Sodium Carbonate | 1.120 |
| Sodium Bicarbonate | 0.560 |
| Active 3-iodo-2-propynyl butyl carbamate (6% in Glycacil) | 0.009 |
| | 100.000 |

Formula 3

| RAW MATERIAL | % WT/ |
|---|---|
| Water | 93.915 |
| Active sodium hydrochlorite | 4.400 |
| Sodium Carbonate | 1.120 |
| Sodium Bicarbonate | 0.560 |
| Active 3-iodo-2-propynyl butyl carbamate (6% in Glycacil) | 0.005 |
| | 100.000 |

Formula 4

| RAW MATERIAL | % WT/ |
|---|---|
| Water | 93.83 |
| Active sodium hydrochlorite | 4.00 |
| Active lithium hydrochlorite | 0.50 |
| Sodium Carbonate | 1.11 |
| Sodium Bicarbonate | 0.56 |
| | 100.000 |

Formula 5

| RAW MATERIAL | % WT/ |
|---|---|
| Water | 94.33 |
| Active sodium hydrochlorite | 3.50 |
| Active lithium hydrochlorite | 0.50 |
| Sodium Carbonate | 1.11 |
| Sodium Bicarbonate | 0.56 |
| | 100.00 |

In connection with the addition of lithium hydrochlorite to a conventional sodium hydrochlorite fungicidal composition, the added components may be in the range of about 0.01% to about 5%, with a narrower range of about 0.1% to about 1%, and with about 0.5% preferred. For IPBC the additive range is from about 0.001% to about 1%, with a preference range of about 0.003% to about 0.009%, with a preferred value of about/5%.

Ordinarily one would expect that the addition of an organic compound such as IPBC to a strong oxidizer such as sodium hypochlorite would result in instability of the combination, but surprisingly that was not the case. The normal bleach solution is stable with the IPBC in it, the solution does not degrade, and it remains active enough to prevent the growth of mildew stains for at least four weeks.

It is to be stressed that while both lithium hypochlorite and IPBC are known to have fungicidal properties neither of those additives were known to have particularly extended active lives when applied individually as fungicides. What was particularly surprising to us was their effect in imparting a long active life to the compositions to which they were added. One particular advantage of the use of IPBC as the additive is that when it is used the pH can be adjusted from a conventional pH value of 12 to a pH value of 11 to allow future stain removal while maintaining stability.

As is well known, sodium hypochlorite fungicide compositions usually include other additives such as sodium carbonate and sodium bicarbonate as in the examples set forth above, as well as a large number of other substances, and the present invention is not limited to the specific formulations here specifically set forth. Instead many variations may be made in those specific compositions without departing from the spirit of the invention as defined in the appended claims.

We claim:

1. A fungicidal composition having long-lasting improved fungi-prevention properties which comprises a selected alkali metal hypochlorite present in an amount sufficient to provide an effective fungicidal action, and one or more of the members of the group consisting of other alkali metal hypochlorites, the active amount of which is present in an amount less than about 5% of the weight of the total composition.

2. The composition of claim 1, in which said selected hypochlorite is sodium hypochlorite and said member is lithium hypochlorite the active amount of which is present in an amount by weight between about 0.01% and about 5% of the weight of the total composition.

3. The composition of claim 1, in which said selected hypochlorite is sodium hypochlorite and said member is lithium hypochlorite the active amount of which is present in an amount by weight between about 0.1% and about 1% of the weight of the total composition.

4. The composition of claim 1, in which said selected hypochlorite is sodium hypochlorite and said member is lithium hypochlorite the active amount of which is present in an amount by weight of about 0.5% of the weight of the total composition.

5. A method of increasing the fungi-prevention properties of a fungicidal alkali metal hypochlorite which comprises adding to a composition in which said hypochlorite is present in an amount sufficient to provide effective fungicidal action, one or more members of the group consisting of other alkali metal hydrochlorites the active amount of which is present in an amount by weight of less than about 5% of the weight of the total composition.

6. The method of claim 5, in which said first-mentioned hypochlorite is sodium hypochlorite and said additive is lithium hypochlorite the active amount of which is present in an amount by weight between about 0.01% and about 5% of the weight of the total composition.

7. The method of claim 5, in which said first-mentioned hypochlorite is sodium hypochlorite and said additive is lithium hypochlorite the active amount of which is present in an amount by weight between about 0.1% and about 1% of the weight of the total composition.

8. The method of claim 5, in which said first-mentioned hypochlorite is sodium hypochlorite and said additive is lithium hypochlorite the active amount of which is present in an amount by weight of about 0.5% of the weight of the total composition.
